(19) United States
(12) Patent Application Publication
(10) Pub. No.: US 2006/0009905 A1
(43) Pub. Date: Jan. 12, 2006

(54) Communication device for alerting passengers of their destination

(76) Inventors: Victor J. Soderberg, Yaphank, NY (US); Hung Truong, Brooklyn, NY (US)

Correspondence Address: Thomas A. O'Rourke;Bodner & O'Rourke, LLP, 425 Broadhollow Road, Melville, NY, 11747, US

(21) Appl. No.: 11/170,772

(22) Filed: Jun. 29, 2005

Related U.S. Application Data
(60) Provisional application No. 60/585,736, filed on Jul. 6, 2004.

(51) Int. Cl. G01C 21/26

(52) U.S. Cl. 701/200

(57) ABSTRACT

A system and method for alerting a person riding on a vehicle of at least one location along the route of the vehicle is disclosed. The system includes a base station, mounted along a track of a railroad transportation system, wherein the base station emits a signal which contains a unique identification designation for a location along the system. The signal that is emitted by the base station is not detectible when the person riding on the vehicle is not present in the vicinity of the base station. The system also includes a personal electronic device adapted to be carried by the user. The personal electronic device is capable of detecting the unique identification designation being transmitted by the base station.

This is a conversion of U.S. Provisional Patent Application Ser. No. 60/585,736, filed Jul. 6, 2004, the disclosures of which are incorporated herein by reference.

### FIELD OF THE INVENTION

The present invention is directed to a communication system or signaling system and method for alerting mass transportation passengers of the approach of their destination.

### BACKGROUND OF THE INVENTION

People, who ride transportation systems, whether public or private, can travel great distances simply by boarding a vehicle such as a bus or train. The two most important parts of using a transportation system are: knowing when, where and which vehicle to board to start the trip and knowing when to exit the vehicle to make connections and changes, so that the rider does travel to their destination but not beyond. A great number of riders, who use transportation systems, usually by no fault of their own, miss their destination. One reason that riders of transportation system fail to depart the vehicle at the correct stop is because they are unaware that they are at the correct stop. Many public address systems in public transportation systems are frequently inoperative, nonexistent or inaudible. Many buses and trains are also very crowded and the passengers, particularly the passengers who are forced to stand, cannot see their stop. There are a number of other reasons why passengers are unaware that they have arrived at the correct stop including: they are asleep, they are mentally handicapped or they are physically handicapped. Many commuters sleep while they are riding on a transportation system because they have to travel such a far distance and they must use transportation systems so that they can get enough sleep each day to function at work.

Most solutions that help combat the problem of missing one's stop on a transportation system require the presence and reliance upon another human being. In the past a conductor would pass through a train car and announce stop, but with the advent of public address systems the use of conductors has been scaled back significantly. Announcements made over public address systems are difficult to understand, not loud enough to wake someone sleeping or would not alert a deaf person at all. If a person is traveling in a group it is no better. Many times, the group is so absorbed in conversation that they are not aware of the location of the train. Also the members of the group could have fallen asleep or the whole group could share a handicap which prevents them from realizing that it is time for them to depart the vehicle. A rider could set a timer to alert them to the time when the vehicle is scheduled to arrive at the stop they are supposed to depart at, however setting a timer assumes that the vehicle will be making all of it's stops on time. If the vehicle is delayed or ahead of schedule setting a timer is useless because the rider could get off prematurely if vehicle is delayed or after their stop has passed if their vehicle is ahead of schedule.

A rider could bring a Global Positioning System device with him on the transportation system to alert the rider of his location on that transportation system. The GPS device could be preset to alert a rider when he got to the latitude and longitude of the stop at which he wants to depart the vehicle. The problem with a GPS device is that civilian GPS devices are subject to government interference which may render them inoperable, such as when the GPS network is shutdown during times of war and the fact that civilian GPS receivers are purposefully made inaccurate so that they cannot be used as weapons. Since civilian GPS receivers are purposefully made inaccurate a person riding on a transportation system may not be alerted that they have arrived at a stop even if they have.

In U.S. Pat. No. 6,347,228 there is described a location apparatus and method in a mobile telecommunications system. This device uses numerous fixed slave nodes to determine the location of a GSM mobile phone. There is no ability to select stations and have a signal sent from a transmitter at a station to a receiver.

### OBJECTS OF THE INVENTION

It is an object of this invention is to alert a person riding on a transportation system that it is time for them to depart from their mode of transportation.

It is an object of the invention to provide a communication system to alert an individual passenger in a transportation system that a selected destination is approaching.

It is an object of the invention to provide a communication system that is compatible with personal electronic devices such as cell phones, PDA's and related portable hardware to inform the individual user of an approaching selected destination.

It is an object of the invention to allow a user to input a series of destinations into a personal electronic device, and the device will tell the user when each one of those destinations has been reached in that order.

It is an object of the present invention to inform a user of the most efficient path to get back on the correct path, if the user gets off of the correct path.

It is an object of the present invention to provide a system to allow a person to more effectively move from one method of transportation such as a train or bus more efficiently.

### SUMMARY OF THE INVENTION

The invention is directed to a system method and apparatus for alerting passengers of station stops and may include a program such as a software program that may be downloaded and installed in a pre-existing personal electronic device such as a cell phone, PDA and the like. In another embodiment, the personal electronic device may have the program pre-installed. The invention may also include a base station for transmitting a signal to the personal electronic device. The program, whether it is one pre-installed or is one which a user can download to an electronic device, will monitor signals the device receives looking for a location, such as a destination inputted by the user. The personal electronic device will preferably be some species of personal electronic device (“PED”) capable of having programs uploaded to it such as a cell phone, personal data assistant or a similar device. The device will be capable of receiving signals being transmitted by a base station and these signals will be transmitted via radio waves preferably using a standard such as Bluetooth, Short Message Service and the like. The base station may be mounted at one or more stops of the transportation system and will transmit data which the device will use to determine if the user has arrived at the preset destination. When the PED detects a base station signal the PED will determine what course of action to take based on options chosen by the user. Actions that the PED may take based on input entered by the user or preset information the user can download to the PED. Actions that the PED may take include but are not limited to: vibrating, sounding a tone, playing music, or turning a light on and off. The PED will take action when certain conditions are met, these conditions include but are not limited to: arriving at a destination, arriving at a point of transfer between vehicles, missing a point of destination, or a user defined condition.

If the user misses a destination or a transfer between vehicles then the PED will give the user a number of options including but not limited to calculating an alternative route to get to the user's destination based on the user's current location.

### BRIEF DESCRIPTIONS OF THE FIGURES

FIG. 1 shows the program being downloaded to the user's device.

FIG. 2 shows the user selecting the destination at which he would like to be alerted.

FIG. 3 shows the device with the destination selected, scanning for the destination.

FIG. 4 shows the device sensing the arrival of the vehicle at the destination and alerting the user.

FIG. 5A-5D illustrates a flow chart diagram for the operation of one embodiment of the system of the present invention.

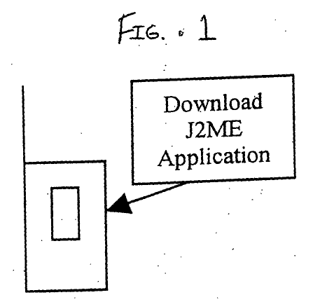

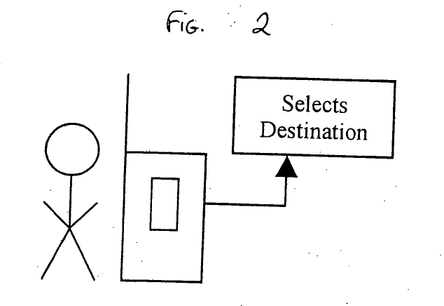

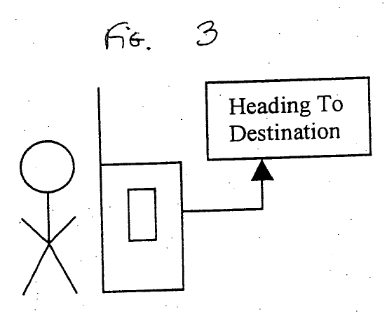

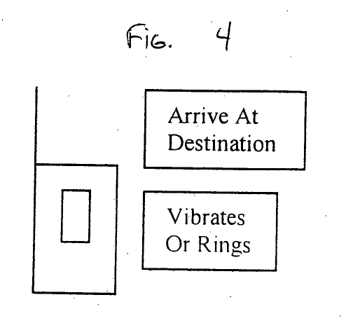

### DETAILED DESCRIPTION OF THE INVENTION

In all of the exemplary embodiments which will be described herein below, there are certain common features which, together with reference to the drawings will be described once here to provide the reader with an easily understood frame work.

The present invention is designed to alert the rider of a transportation system that they have arrived at their destination and that it is time for them to depart the vehicle. The invention consists of a program or application which runs on a personal electronic device (“PED”) which receives signals from a base station or access point which is located at preferably each stop along the transportation system.

The application may be downloaded onto the user's personal electronic device or it can be pre-installed thereon, updates to the system can also be provided as necessary. The download can be accomplished in a number of ways such as downloading the application from the internet, or a similar network, using the device itself, downloading the application to a personal computer and uploading the application to the device or the application can come preinstalled on the device by the vendor of the device. The application may include an installer (which may be a module of this application or a separate application or an HTTP link to accommodate this), to install the application on the device, a user interface, which allows the user to interact with the application and the application root which performs the functions assigned to the application by the user. In one embodiment, this application does not include a backend which typically refers to Database functions and the like (i.e., stored procedures, data objects, etc, which may be merely an application that can be downloaded via TCP/IP (HTTP) and then executed as a client installed app). In another embodiment this application includes these features.

When the application is downloaded to the user's device the installer may be executed. Alternatively, the application may just require downloading to the appropriate directories on the cell phone. The application is configured to the specifications of the user's device. Such specifications include but are not limited to the communication protocol used by the device and a list of stops along the route which the user's mode of transportation follows. Communication protocols which could be used by the device include but are not limited to Blue Tooth, Short Message Service (including Cell Broadcast Service SMS-CB), 802.11, Infrared (IrDA), and TCP/IP and HTTP, for downloading to the device.

The user interface acts as the intermediary between the user and the application. The user interface prompts the user to enter input such as but not limited to what stop on the transportation system the device should listen for, how to alert the user when the specified stop is detected, what stop the vehicle is currently at, what the last stop the vehicle made was, the distance to the destination, the estimated time to the destination, and the time of the last station passed.

The application performs all of the tasks which the user inputs into the device through the user interface. When the user interface passes information to the application the application executes those commands. The application controls all of the communications protocols, analyzes the information gathered by the device and decides if the user should be alerted and how the user should be alerted. The application can use protocols including but not limited to Bluetooth and Short Message Service to communicate with base stations at stops along the transportation system. When the user specifies what stop the device should listen for the application will put the device into a listening mode and begin analyzing all of the information collected while the device is listening. The user can specify one stop at which to be alerted or the user can create a list one or more stops at which the device should alert the user if for example transfers were necessary. A user would create a list of one or more stops for reasons including but not limited to they have to change from one vehicle to another at a stop and continue traveling to their destination on the second vehicle. The application allows the user to save lists of stops on the device using a name specified by the user, these lists of stops can be recalled by the device for later use. When the application hears and confirms a signal is from the base station at the stop that the user wants to be alerted to the arrival of, then the application will alert the user. The application can also be set to alert the user if a stop at which the user should not be is detected by the device, an example of when this would be useful includes but is not limited to if the user was supposed to change vehicles while enroute, failed to do so and is now continuing to travel on the wrong vehicle. The application can alert the user in a variety of ways including but not limited to one or more of the following flashing the screen of the user's device, instructing the device to emit an audible tone, or instructing the device to vibrate. The user can specify different methods of alert for each of the events described herein including but not limited to, arriving at the user's destination, arriving at a stop at which the user changes vehicles, or arriving at a stop the user should not be at.

The user's device becomes aware that the user has arrived at his pre-selected destination because the device senses a signal from a base station which is located at the stop the user has pre-selected. Every stop along the transportation system is equipped with one of these base stations. Base station is a synonym for a number of other names including but not limited to access point and base transceiver station but the essential function of the device does not change. The purpose of a base station is to provide means to transmit the identity of the stop at which the base station is located. The identity of the stop can be a combination of numbers and characters limited only by the transmission protocol being used by the device. In addition to informing a user's device of what station the user has arrived at by transmitting its ID the base station may perform other functions including but not limited to, providing internet access to the user's device, allow the device to listen for unauthorized access, or download additional items to the device. The base station may use a variety of protocols including but not limited to Bluetooth, Short Message Service, Wireless Local Area Network (802.xx), SMS-CB (cell broadcast), Infrared (IrDA), or Carrier Assigned Frequencies to communicate with the user's device.

Alternatively, with reference to a railroad system, the base station(s) may be situated on the train itself, and, with reference to the communication protocols cited above, the appropriate base station can be manually triggered to emit a signal (on the appropriate port if applicable) indicating to the mobile device that they have arrived at a particular destination.

If the invention utilized the Bluetooth standard of communication then there are two main stages that a Bluetooth device must go through to acknowledge the existence of another Bluetooth device the first is Device Discovery the second is Service Discovery. In the device discovery mode the user's device is searching for other devices offering Bluetooth services. With respect to this application, it is searching specifically for a network “Access Point”. Access point is a term of art for a Bluetooth base station. When the user device detects the presence of an access point the device switches to the service discovery mode. When the user's device is in service discovery mode it would query the access point for the access point's unique identification such as a number to determine what type of access point the device is communicating with and/or would query a manually configured unique service attribute ID. For the purpose of this invention the unique identifying number would be the method by which the application being run on the user device would determine which stop on the transportation system the user was currently located.

If the invention use Short Message Service Cell Broadcast Technology then the application runs in the background on the user's device waiting to a wireless message to be delivered to the device. The term of art for a Short Message Service base station is Base Transceiver Station (BTS). The range of BTSs can be pre-configured to optimally alert a user when they are in range of their selected destination. When the mobile device is in range of the BTS a wireless message will be delivered to the user device. If the content transmitted by the BTS matches the values which indicate the destination chosen by the user then the application would alert the user that they have arrived at their destination. Also, if a uniform message was transmitted by all BTS's but each destination transmitted this message on a particular port, the application would only listen for this message at the port indicative of the destination chosen by the user and when received would be interpreted by the application as the arrival of the selected destination (i.e., User selects a station such as Jamaica which broadcasts at port 1000, the user who boards at Ronkonkoma heading westward and passes Hicksville, Hicksville would transmit the uniform message at port 1001. The application would not be able to read this message since it is at a different port).

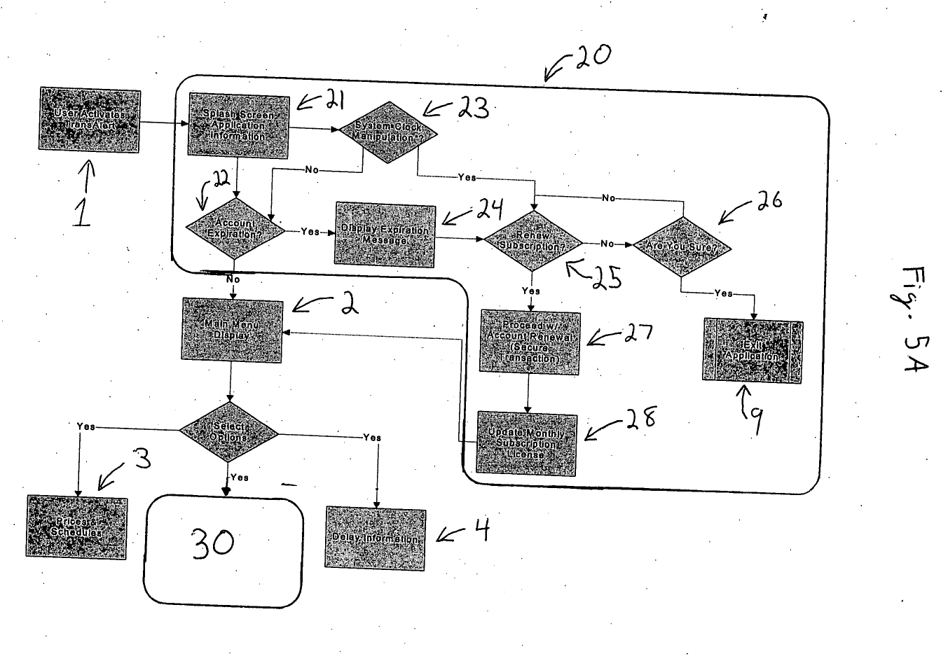

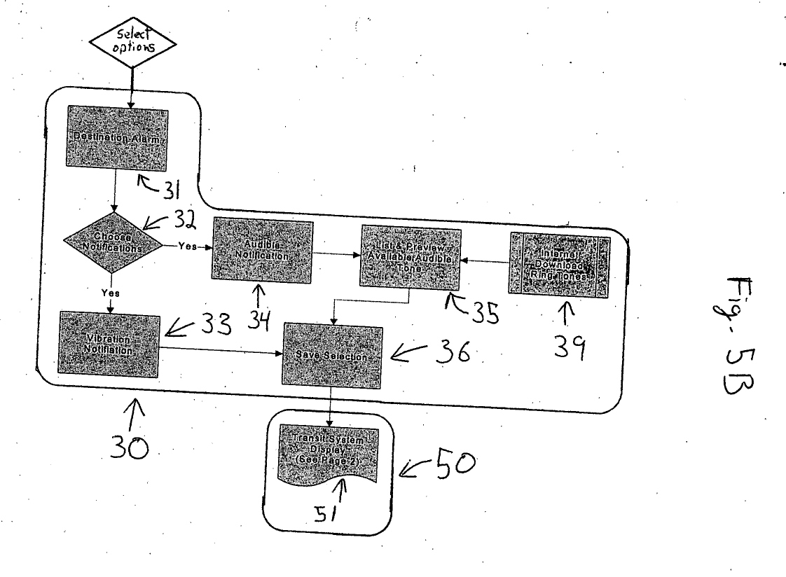

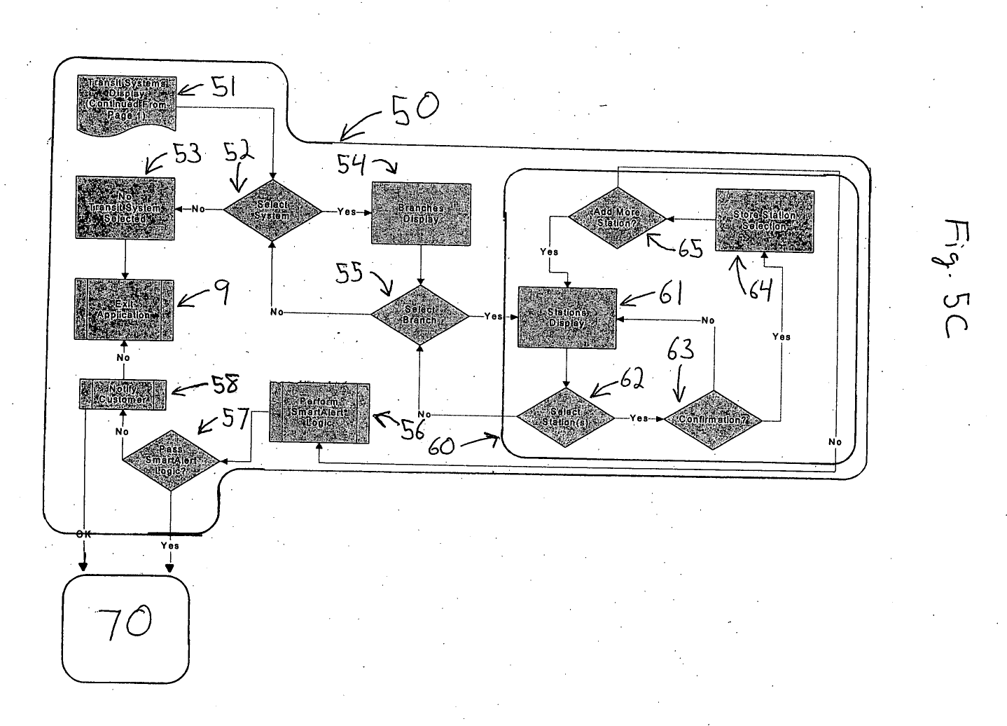

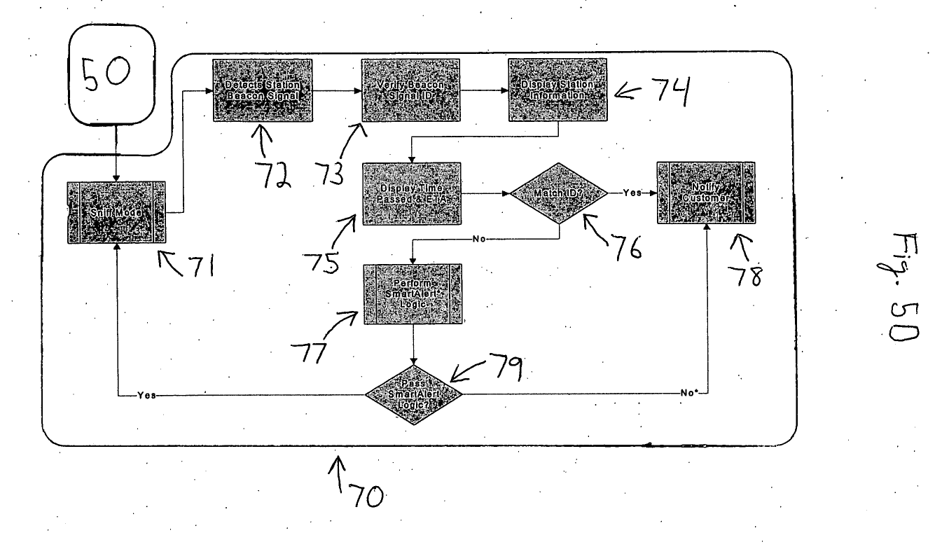

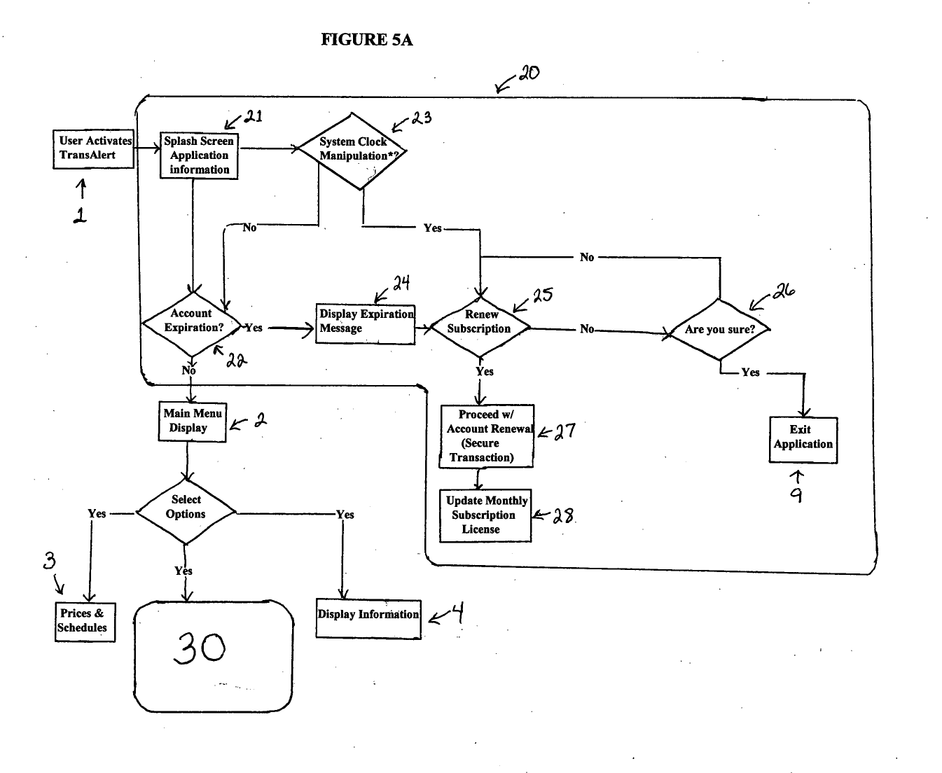

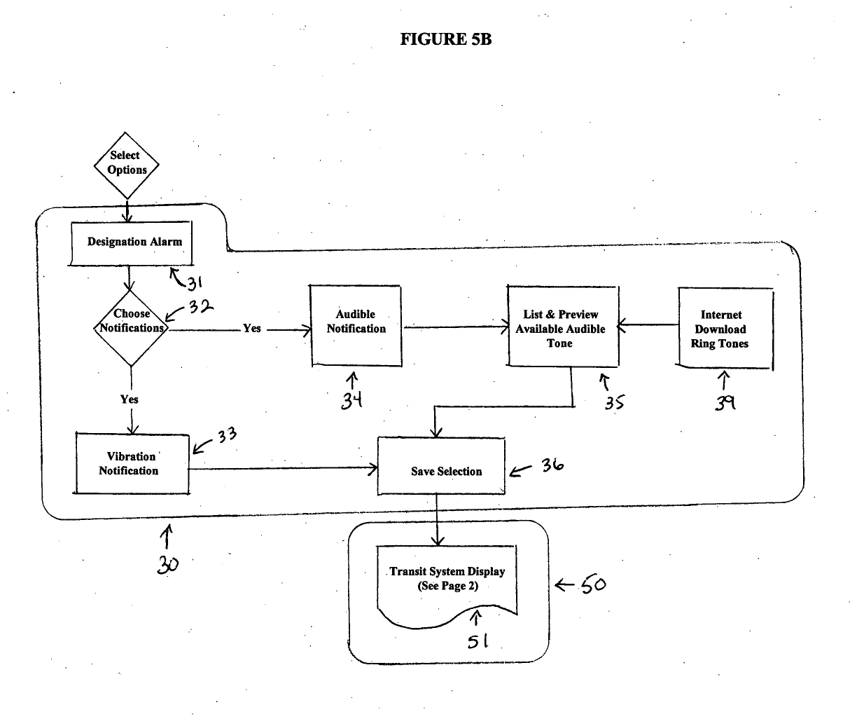

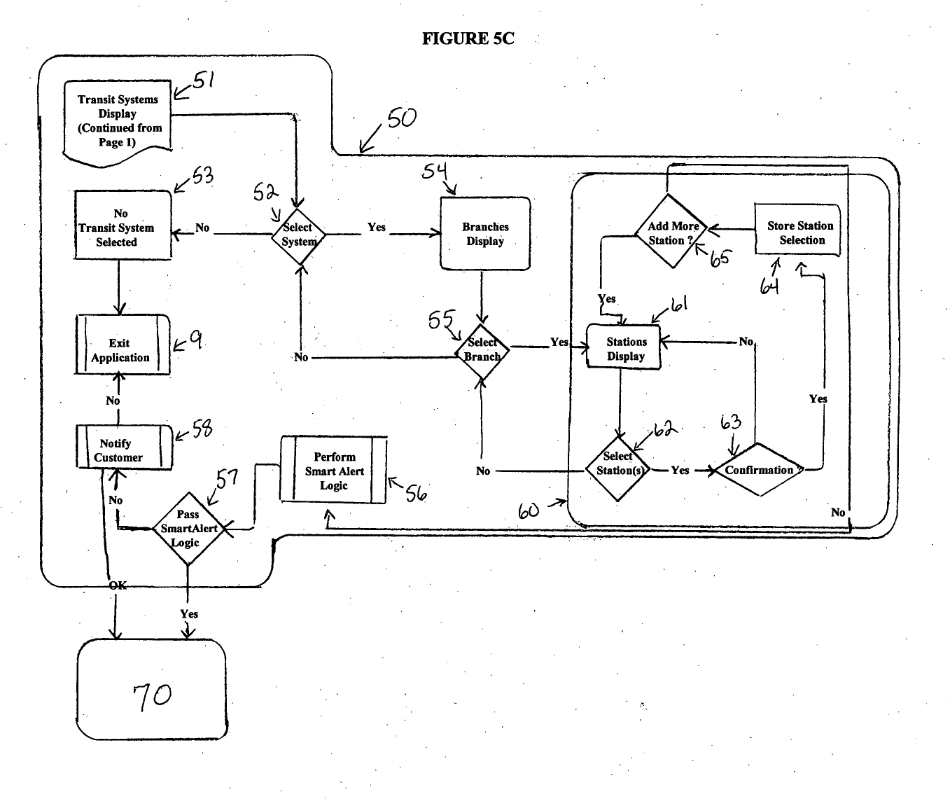

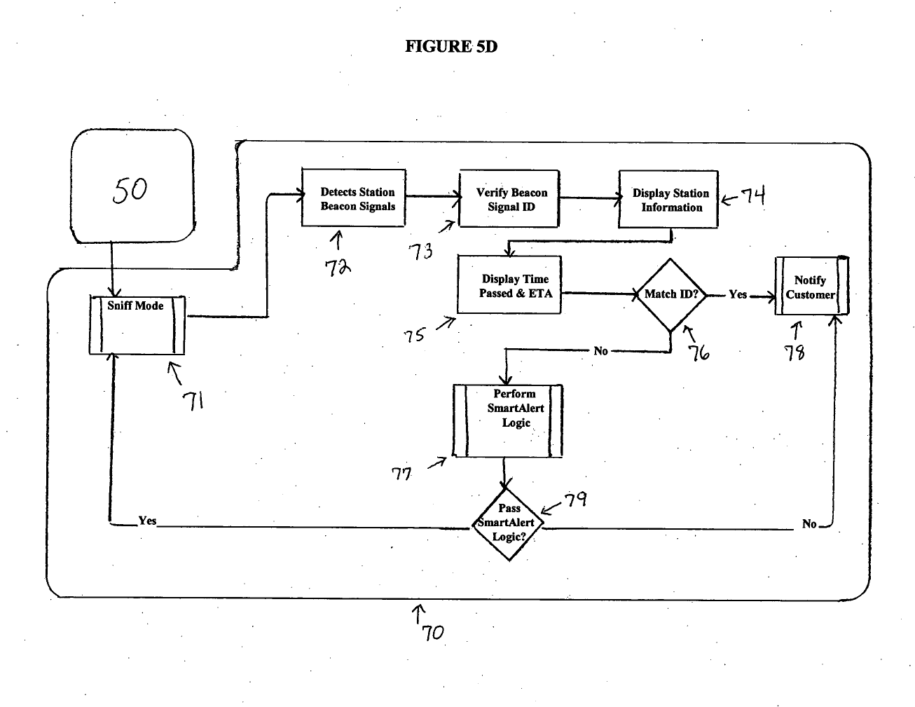

FIG. 5 illustrates a preferred embodiment of the present invention. In this illustration the present invention is referred to by the designation “TransAlert”. The TransAlert system has a number of main routines, including but not limited to an account checker routine 20, a notification routine 30, a transit system routine 50, a station display routine 60, and a sniff mode routine 70. The account checker 20 verifies that the user of the present invention has a valid account and is authorized to use the system. The notification routine 30 lets the user choose how to be notified when the user is at the correct destination. The transit system routine 50 selects which branch the present invention will display. The station display routine 60 selects which station the present invention will display. The sniff mode routine 70 is the state TransAlert goes into when the user has selected a destination and is traveling. The present invention may have additional routines including but not limited to a routine to display prices and schedules or 3 to calculate delay information 4. Each one of these routines may have a number of subroutines.

The purpose of said account checker routine 20 is to determine if the user attempting to access the system is authorized to do so. When a user activates TransAlert 1 the system may display a splash screen 21 which gives general information relating to the system and gives the user the option of logging into the TransAlert system. When the user requests access to the TransAlert system, TransAlert check to see if the system clock has been manipulated 23. TransAlert detects system clock manipulation by comparing the current date to the date TransAlert was last operated, if the date of last operation is greater than the correct date then the clock has been manipulated and TransAlert goes to the Subscription Renewal Subroutine 25. If the date of last operation is less than the current date or is null, then TransAlert will save the current date and proceed to the Account Expiration Subroutine 22.

The purpose of the Account Expiration Subroutine 22 is to determine if the user has a valid subscription to use TransAlert. TransAlert compares the term for which the user is authorized to use the system with the current date, if the term which the user is allowed to use the system has expired then TransAlert display a message indicating that the user's account has expired and then goes to the Subscription Renewal Subroutine 25. If the user's subscription term has not expired then TransAlert goes to the Main Menu Display Subroutine 2.

The purpose of the Subscription Renewal Subroutine 25 is to renew the user's rights to use the TransAlert system. The Subscription Renewal Subroutine 25 asks the user whether the user would like to renew the right to use TransAlert, if the user answers in the affirmative then the user's subscription account will be renewed through a secured transaction 27 and the user's monthly subscription license will be updated 28 and TransAlert will goto the Main Menu Display Subroutine 2. If the user answers in the negative about renewing the user's subscription to TransAlert, the system will ask the user if the user is sure 26, if the user answers in the negative then TransAlert will move back to the beginning of the Subscription Renewal Subroutine 25, if the user answers in the affirmative then the user will exit from the TransAlert system 9.

The purpose of the Main Menu Display Subroutine 2 is to display to the user the different options from which the user may choose. From the Main Menu Display Subroutine 2 the user may navigate to routines such as a price and schedule routine 3, a delay information routine 4, or a transit system display routine 50.

When the user selects the transit system display routine 50 the notification routine 30 may be invoked, however if the user has used the system in the past the notification routine 30 may be omitted, or it may have default values which the user may change by choosing to navigate to the notification routine 30 from the Main Menu Display subroutine 2. A person of ordinary skill will recognize that there are a number of ways to invoke the notification routine 30. The purpose of the notification routine 30 is to choose how the TransAlert system will alert the user when the user arrives at a station at which the user has chosen to receive an alert. The notification routine 30 allows the user to select the method of notification 32 either, vibration 33 or audible 34, if the user selects an audible notification 34 then the user may select from a list of available audible tones 35 and may even download audible ring tones from the internet 39. Once the user has selected the type of notification to use, that selection is saved 36 and TransAlert goes to the transit system display routine 50.

The purpose of the transit system display routine 50 is to allow the user to select what transit system the user wishes to travel on. Some examples of transit systems which this system may be used with include but are not limited to bus lines, subways, rail roads, roads for automobile usage, and ferries. If the user has not already selected a transit system, then the user will be prompted to do so 52, if the user does not wish to select a transit system 53 then the TransAlert system will exit 9. If the user selects a transit system then a list of the branches on that transit system will be displayed 54. The user will be prompted to select a branch 55, if the user does not want to select a branch then TransAlert will return to the transit system selection menu 52. If the user selects a branch then a listing of the stations on that branch will be displayed 61. The user will be prompted to select a station 62, if the user does not want to select a station then TransAlert will return to the branch selection menu 55. If the user selects a station, that station will be stored by Trans Alert 64 and the user will be asked if there are more stations to be selected 65. If the user does not wish to choose any more stations then TransAlert will goto the sniff mode routine 70, if the user does wish to add more stations then TransAlert will goto back to the station select menu 61.

The purpose of the sniff mode routine 70 is to determine if the stations which the user has told the TransAlert system are logical 56, to listen for the stations which the user has told the TransAlert system to listen for 71, to trigger the method of notification once the TransAlert system has heard the station's identification beacon 78, and to determine if the user has missed the user's destination station 77. The sniff mode routine first passes the list of stations which the user has saved through an algorithm which determines if the stations chosen by the user are logical 56, 57, if the stations chosen by the user do not make sense then the user will be warned of this fact 58 and can choose to ignore the warning. An example of an illogical station selection includes but is not limited to choosing a station which cannot be reached from the user's point of origin. The TransAlert system also check the stations selected to see if transfers between vehicles are necessary for the user to get to the specified destination. If transfers are necessary TransAlert will prompt the user to add those transfer stations to the list of stations selected by the user 58.

Once the stations selected by the user have passed the logic portion of the sniff mode routine, TransAlert will being listening for the signals 71 from the base stations which are positioned at each station. When the vehicle in which the user is traveling in passes near a base station TransAlert may detect the base station information 72, verify the base station identification number 73, display the station information 74, and display the time and date the station was detected 75. TransAlert will then compare the identification of the base station with the identifications of the stations which the user has told TransAlert to alert the user about 76. If the identification of the base station matches one of the stations on the user's list then TranAlert will alert the user in the method which the user specified 78. If the identification of the base station does not match any of the stations on the user's list then TransAlert will apply the identification to an algorithm to determine if there is a problem 77.

TransAlert will compare the base station identification of the station the user has just encountered with the base station identifications of other stations along the user's route 77, if TransAlert determines that the base station the user has just encountered is not one which the user should have encountered 79, then TransAlert will notify the user of this problem 78. TransAlert will perform this operation by verifying if a station passed indicates the user is on the wrong train, of if the station passed is beyond the user's destination. If TransAlert determines that the base station identification is one which the user should have encountered then TransAlert will return to listening for the signals of other base stations 71.

One skilled in the art will recognized that the above mentioned example may be implemented in a number of ways, with additions and subtractions of features.

Example of the Invention in Use.

1. User buys a new cell phone which is equipped with for example Bluetooth and the application described herein.

2. The user commutes to work in the morning using the train so when he wakes up in the morning he programs his cell phone to alert him when he arrives at the train station at which he departs the train to get to work and at all transfer points in between.
a. When the user finalizes which stop of the train he wants to be alerted at the user interface passes the information to the application.
The application tells the cell phone to begin listening for Bluetooth signals which are from the access point at the train station the user wants to be alerted of.

3. The user boards the train he takes to get to work in the morning and falls asleep.

4. The train the user is on passes through one train station which is not the station that the user wants to be alerted of.
a. The application detects the signal from the Bluetooth access point at the current train station.
b. The application analyzes the information in the signal and compares the information with that of the stop at which the user wants to be alerted.
c. The application sees that the station at which the train is currently at is not the one of which the user wants to be alerted and presents this information (with the time when this station was passed) to the user so they are informed of the progress of their journey. However, notification does not take place for this scenario.

5. The train the user is on arrives at the stop at which the user wants to be alerted.
a. The application detects the signal from the Bluetooth access point at the train station.
b. The application analyzes the information in the signal and compares the information with that of the stop at which the user wants to be alerted.
c. The application sees that the train has arrived at the stop at which the user wished to be alerted so the application tells the cell phone to vibrate and ring.

6. The user wakes up and silences the cell phone or ceases the vibration of the device
a. The user presses a key on the cell phone which indicates to the user interface that the user acknowledges that he has arrived at the predetermined stop.
b. The user interface informs the application that the user has acknowledged arrival at the predetermined stop.
c. The application tells the cell phone to stop ringing and vibrating.
d. The application resets the preset destination so that the cell phone is not triggered again while the user is exiting the station.
e. If multiple destinations are selected, the application continues to listen for the next station selection(s). One additional note, the application can perform one or more additional feature—multiple stops can be saved under one label heading (i.e., ‘Morning stops’ would include Jamaica and Hunterspoint Ave).

7. Furthermore, as each station is passed, statistical data such as ‘quickest time reached while passing station X’ is calculated and can be presented through a menu choice in the application. This information would be helpful in determining the quickest route to a particular destination.

I claim:

1. A system for alerting a person riding on a vehicle of at least one location along the route of the vehicle comprising:
(a) a base station, mounted along a track of a railroad transportation system, wherein;
i. said base station emits a signal which contains a unique identification designation for a location along the system;
ii. said signal not being detectible when the person riding on the vehicle is not present in the vicinity of the location;
(b) a personal electronic device adapted to be carried by said person, said personal electronic device being capable of detecting said unique identification designation being transmitted by said base station, wherein;
i. said personal electronic device being adapted to be programmed to receive said signal when the vehicle is not present in the vicinity of the location.

2. The system according to claim 1 wherein the base station is mounted in the vicinity of a stop.

3. A method of alerting a person riding on a vehicle of the approaching of a stop comprising:
(a) entering an identification designation of a location along a transportation system into a portable electronic device;
(b) said portable electronic device receiving at least one signal from one or more base station along a user's route on a transportation system, each base station containing the identification designation corresponding to a stop along said transportation system;
(c) said portable electronic device signaling said person once a predetermined signal containing the identification of a selected stop along the transportation system is received by the portable electronic device.

4. The method of claim 3, wherein a second base station signals said personal electronic device when a location not along a selected route of the transportation system is approached by said portable electronic device.

5. The system according to claim 2 where the portable electronic device has a user interface that prompts a user to input what stop on the transportation system the device should listen for, an alert form for the user when a specified stop is detected, what stop the vehicle is currently at and what the last stop the vehicle made was.

6. The system according to claim 5 wherein the portable electronic device has a user interface that prompts a user to input the distance to the destination, the estimated time to the destination, and the time of the last station passed.

7. The system according to claim 1 comprising a plurality of routines said routines including an account checker routine, a notification routine, a transit system routine, a station display routine, and a sniff mode routine.

8. The system according to claim 7 wherein the account checker routine verifies that the user of the present invention has a valid account and is authorized to use the system.

9. The system according to claim 8 wherein the notification routine lets the user choose how to be notified when the user is at the correct destination.

10. The system according to claim 9 wherein the transit system routine selects which branch of the system that a portable electronic device will display.

11. The system according to claim 10 wherein the station display routine selects which station the portable electronic devices will display.

12. The system according to claim 11 wherein the sniff mode routine is the state of the system when the user has selected a destination and is traveling.

13. The system according to claim 12 wherein there is a routine to display prices and schedules.

14. The system according to claim 13 wherein there is a routine to calculate delay information.

15. The system according to claim 14 wherein the account checker routine determines if a system clock has been manipulated, said manipulation being determined by comparing the current date to a date the portable electronic device was last operated using the system, and wherein if the date of last operation is greater than a subscription termination date then the system goes into a Subscription Renewal Subroutine.

16. The system according to claim 15 wherein if the date the portable electronic device was last operated using the system is less than the current date or is null, then the system will save the current date and proceed to an Account Expiration Subroutine which determines if the user has a valid subscription to use the system.

17. The system according to claim 16 where if said user has a valid subscription said system proceeds to a Main Menu Display Subroutine 2 is to display to the user the different options from which the user may choose.

18. The system according to claim 17 wherein the sniff mode routine determines if one or more of the stations which the user has inputted into the system are logical, and to listen for the stations which the user has told the the system to listen for, to trigger the method of notification once the system has heard the station's identification signal, and to determine if the user has missed the user's destination station.

19. The system according to claim 18 wherein the sniff mode routine first passes the list of stations which the user has saved through an algorithm which determines if the stations chosen by the user are logical, if the stations chosen by the user do not make sense then the user will be warned of this fact and can choose to ignore the warning.
